(19) United States
(12) Patent Application Publication
(10) Pub. No.: US 2025/0039935 A1
(43) Pub. Date: Jan. 30, 2025

(54) ENHANCED RESTRICTED ACCESS WINDOW MECHANISM FOR LOW LATENCY TRANSMISSION

(71) Applicant: Newracom, Inc., Irvine, CA (US)

(72) Inventor: Heejung Yu, Daejeon (KR)

(21) Appl. No.: 18/917,338

(22) Filed: Oct. 16, 2024

Related U.S. Application Data
(63) Continuation of application No. PCT/US23/17780, filed on Apr. 6, 2023.
(60) Provisional application No. 63/363,637, filed on Apr. 26, 2022.

(51) Int. Cl. H04W 74/0816; H04W 74/08

(52) U.S. Cl. CPC H04W 74/0816; H04W 74/0866

(57) ABSTRACT

Disclosed herein is a method by wireless device functioning as an access point (AP) in a wireless network for allocating an enhanced restricted access window (RAW) for low latency transmission. The method includes generating a beacon frame that includes information for allocating a RAW that includes one or more RAW slots that each includes a LLT contention period and a non-LLT contention period and wirelessly transmitting the beacon frame to allocate the RAW.

### CROSS-REFERENCE TO RELATED APPLICATION

This application is a Continuation of Application No. PCT/US2023/017780, filed Apr. 6, 2023, which claims the benefit of U.S. Provisional Application No. 63/363,637, filed Apr. 26, 2022, which is hereby incorporated by reference.

### TECHNICAL FIELD

The present disclosure generally relates to wireless communications, and more specifically, relates to an enhanced restricted access window mechanism for low latency transmission.

### BACKGROUND

Institute of Electrical and Electronics Engineers (IEEE) 802.11 is a set of physical and Media Access Control (MAC) specifications for implementing Wireless Local Area Network (WLAN) communications. These specifications provide the basis for wireless network products using the Wi-Fi brand managed and defined by the Wi-Fi Alliance. The specifications define the use of the 2.400-2.500 Gigahertz (GHz) as well as the 4.915-5.825 GHz bands. These spectrum bands are commonly referred to as the 2.4 GHz and 5 GHz bands. Each spectrum is subdivided into channels with a center frequency and bandwidth. The 2.4 GHz band is divided into 14 channels spaced 5 Megahertz (MHz) apart, though some countries regulate the availability of these channels. The 5 GHz band is more heavily regulated than the 2.4 GHz band and the spacing of channels varies across the spectrum with a minimum of a 5 MHz spacing dependent on the regulations of the respective country or territory.

WLAN devices are currently being deployed in diverse environments. These environments are characterized by the existence of many Access Points (APs) and non-AP stations (STAs) in geographically limited areas. Increased interference from neighboring devices gives rise to performance degradation. Additionally, WLAN devices are increasingly required to support a variety of applications such as video, cloud access, and offloading. Video traffic is expected to be the dominant type of traffic in WLAN deployments. With the real-time requirements of some of these applications, WLAN users demand improved performance.

The IEEE 802.11ah Task Group has developed an amendment to the 802.11 standard targeting the Internet of Things (IoT) application and extended range (ER) applications by defining sub-1-GHz (S1G) license-exempt operation. IoT is considered the next major growth area for the wireless industry of home appliances and industrial automation, asset tracking, healthcare, energy management, and wearable devices. IoT devices are typically powered by a small battery and require low power consumption.

A restricted access window (RAW) mechanism may be used to improve energy efficiency while reducing conflicts between stations. A RAW mechanism may allocate one or more RAWs. Stations may be divided into RAW groups and assigned to RAWs. Each RAW may include multiple RAW slots. The stations assigned to a RAW may be further divided into subgroups and assigned to RAW slots included in the RAW. During a RAW slot, only the stations assigned to that RAW slot are allowed to access the wireless medium (e.g., through channel contention). The use of a RAW mechanism reduces collision probability, particularly in dense scenarios (e.g., when there are many stations that might contend for access to a wireless medium simultaneously). The use of RAW may help increase throughput and energy efficiency.

With conventional RAW mechanisms, stations are grouped and assigned to RAW slots in a random manner. Low latency transmission (LLT) stations may only access the channel during their assigned RAW slots, which may increase the latency of their transmissions

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example wireless local area network (WLAN) with a basic service set (BSS) that includes a plurality of wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates Inter-Frame Space (IFS) relationships, in accordance with some embodiments of the present disclosure.

FIG. 5 illustrates a Carrier Sense Multiple Access/Collision Avoidance (CSMA/CA) based frame transmission procedure, in accordance with some embodiments of the present disclosure.

FIG. 6 shows a table listing various characteristics of Institute of Electrical and Electronics Engineers (IEEE) 802.11ah, according to some embodiments.

FIG. 7 is a diagram showing an example of a restricted access window (RAW) and a RAW slot in IEEE 802.11ah.

FIG. 8 is a diagram showing the use of a beacon frame that includes a RAW parameter set (RPS) element to allocate RAWs.

FIG. 9 is a diagram showing an enhanced RAW mechanism, where RAW slots are divided into a low latency transmission (LLT) contention period and a non-LLT contention period, according to some embodiments.

FIG. 10 is a diagram showing a network with RAW groups having different ratios of the number of LLT stations to the number of non-LLT stations, according to some embodiments.

FIG. 11 is a diagram showing an enhanced RAW in which different RAW slots have different LLT contention period durations, according to some embodiments.

FIG. 12 is a diagram showing hierarchical structure for association identifier (AID) assignment.

FIG. 13 is a diagram showing a RAW parameter set (RPS) element format in IEEE 802.11ah, according to some embodiments.

FIG. 14 is a diagram showing a table of an interpretation of the RAW type field and the RAW type options field in IEEE 802.11ah, according to some embodiments.

FIG. 15 is a diagram showing a table of an interpretation of the RAW type options field, according to some embodiments.

FIG. 16 is a diagram showing a table of an interpretation of the RAW type options field and the channel indication reserved field, according to some embodiments.

FIG. 17 is a diagram showing a RA frame format when the slot assignment mode is “0”, according to some embodiments.

FIG. 18 is a diagram showing a RA frame format when slot assignment mode is “1”, according to some embodiments.

FIG. 19 is a diagram showing low latency transmission using periodic RAWs, according to some embodiments.

FIG. 20 is a flow diagram of a method (e.g., performed by an access point (AP)) for implementing an enhanced RAW mechanism for low latency transmission, according to some embodiments.

FIG. 21 is a flow diagram of a method (e.g., performed by a LLT station) for implementing an enhanced RAW mechanism for low latency transmission, according to some embodiments.

### DETAILED DESCRIPTION

The present disclosure generally relates to wireless communications, and more specifically, relates to an enhanced restricted access window mechanism for low latency transmission.

As mentioned above, with conventional RAW mechanisms, stations are grouped and assigned to RAW slots in a random manner. Low latency transmission (LLT) stations may only access the channel during their assigned RAW slots, which may increase the latency of their transmissions.

Embodiments are disclosed herein that provide an enhanced RAW mechanism that allows for low latency transmission. According to some embodiments, the enhanced RAW mechanism divides a RAW slot into two parts. The first part is a LLT contention period during which LLT stations included in the network are allowed to attempt transmission. The second part is a non-LLT contention period during which only stations assigned to the RAW slot are allowed to attempt transmission. The enhanced RAW mechanism may give priority to LLT stations during RAW slots so that their latency requirements can be satisfied.

An embodiment is a method performed by a wireless device functioning as an access point (AP) in a wireless network. The method may include generating a beacon frame that includes information for allocating a restricted access window (RAW) that includes one or more RAW slots that each includes a low latency transmission (LLT) contention period and a non-LLT contention period. The method may further include wirelessly transmitting the beacon frame to allocate the RAW.

An embodiment is a method performed by a wireless device functioning as a LLT station in a wireless network. The method may include receiving a beacon frame from an AP that includes information for allocating a RAW, determining, based on the information for allocating the RAW, that the RAW includes a RAW slot that includes a LLT contention period and a non-LLT contention period, and attempting to access a wireless medium during the LLT contention period of the RAW.

For sake of illustration, various embodiments are primarily described herein in the context of wireless networks based on IEEE 802.11 standards using terminology thereof. However, embodiments are not limited thereto. Those skilled in the relevant art will appreciate that the enhanced RAW mechanism disclosed herein can be used in other types of wireless networks.

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

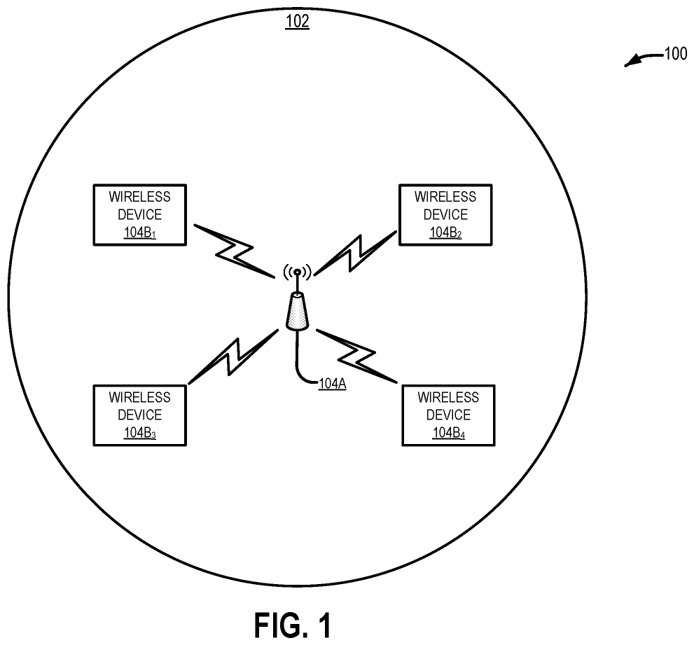

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B1-104B4 that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B1-104B4) may be collectively referred to as STAs. However, for case of description, only the non-AP STAs may be referred to as STAs. Although shown with four non-AP STAs (e.g., the wireless devices 104B1-104B4), the WLAN 100 may include any number of non-AP STAs (e.g., one or more wireless devices 104B).

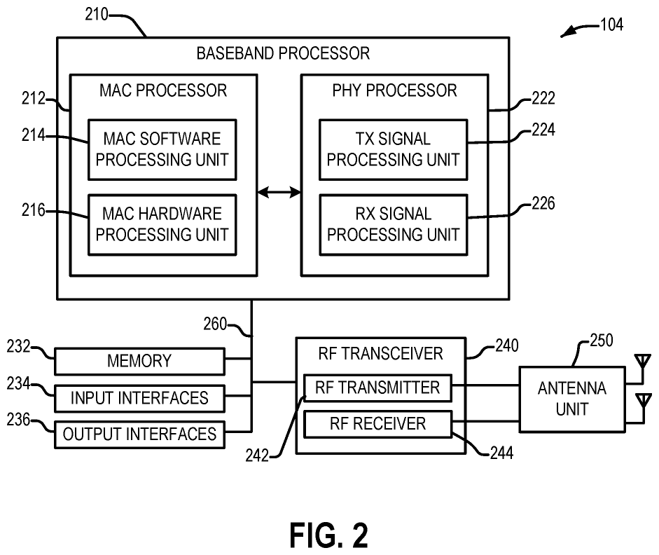

FIG. 2 illustrates a schematic block diagram of a wireless device 104, according to an embodiment. The wireless device 104 may be the wireless device 104A (i.e., the AP of the WLAN 100) or any of the wireless devices 104B1-104B4 in FIG. 1. The wireless device 104 includes a baseband processor 210, a radio frequency (RF) transceiver 240, an antenna unit 250, a storage device (e.g., memory) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

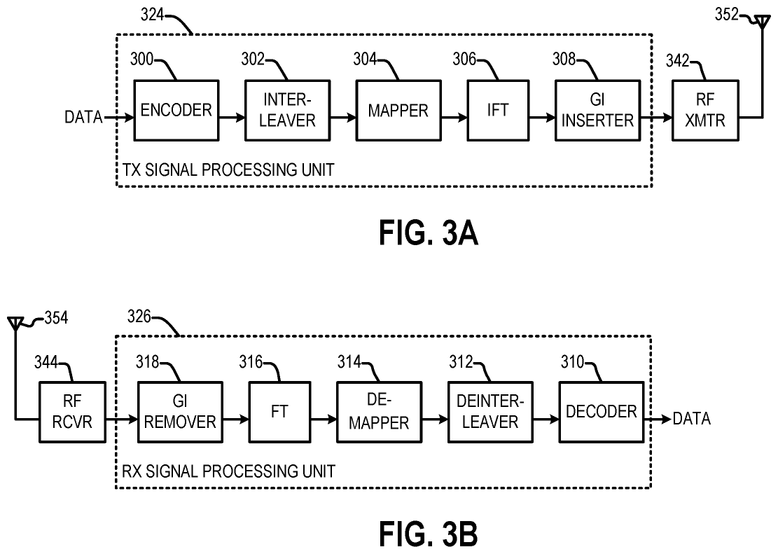

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In cither OFDM or OFDMA Physical (PHY) layers, a STA (e.g., a wireless device 104) is capable of transmitting and receiving Physical Layer (PHY) Protocol Data Units (PPDUs) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

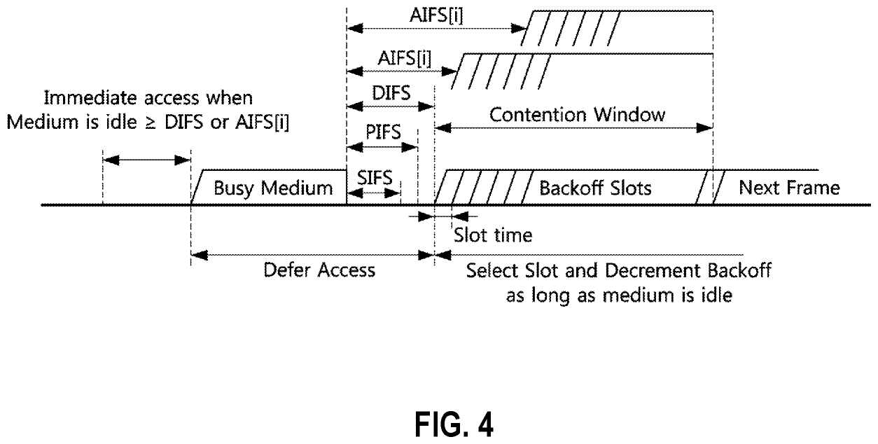

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

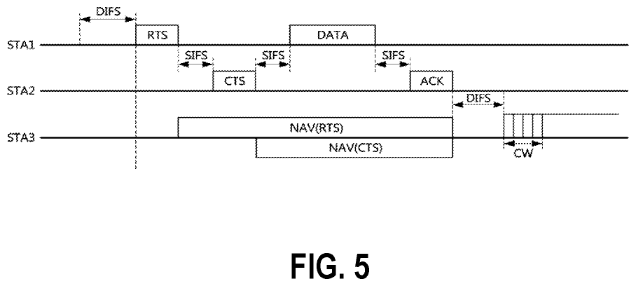

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

As mentioned above, the IEEE 802.11ah Task Group has developed an amendment to the 802.11 standard targeting the Internet of Things (IoT) application and extended range (ER) applications by defining sub-1-GHz (S1G) license-exempt operation. IoT is considered the next major growth area for the wireless industry of home appliances and industrial automation, asset tracking, healthcare, energy management, and wearable devices. IoT devices are typically powered by a small battery and require low power consumption.

Although S1G bands have more limited frequency spectrum available than 2.4 and 5 GHz ISM bands, the basic assumption is it would be sufficient enough for low data rate applications such as IoT applications. IoT applications typically transmit small amounts of data infrequently. Moreover, since the 915 MHz ISM band (902-928 MHz) has 8.5 dB less free space propagation loss than 2.4 GHz ISM band, this could allow to enhance either the link budget between devices or long-range transmission for outdoor circumstances. Those properties can help reduce energy consumption of a device by lowering transmit power as well.

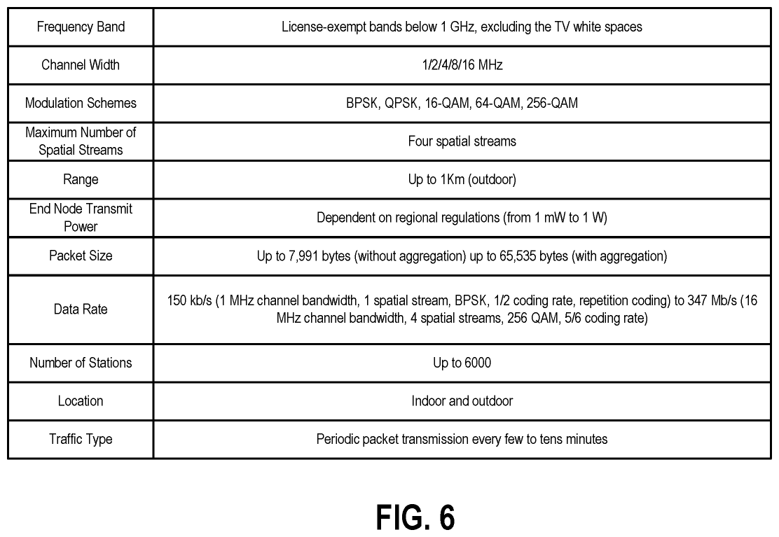

FIG. 6 shows a table listing various characteristics of 802.11ah, according to some embodiments.

In a WLAN environment that is based on the IEEE 802.11ah standard, a single AP may have up to 8,192 stations connected to it. If all of the stations are allowed to compete for channel access at the same time, the stations may need to stay in an awake mode for a long period of time before being able to successfully access the channel. This increases the transmission time delay and increases power consumption due to repeated collisions.

A RAW mechanism has been introduced to improve energy efficiency while mitigating collisions between stations. A RAW may be divided into multiple RAW slots. Stations of a wireless network may be grouped and assigned to RAW slots. Only stations assigned to a RAW slot are allowed to contend for channel access during the RAW slot.

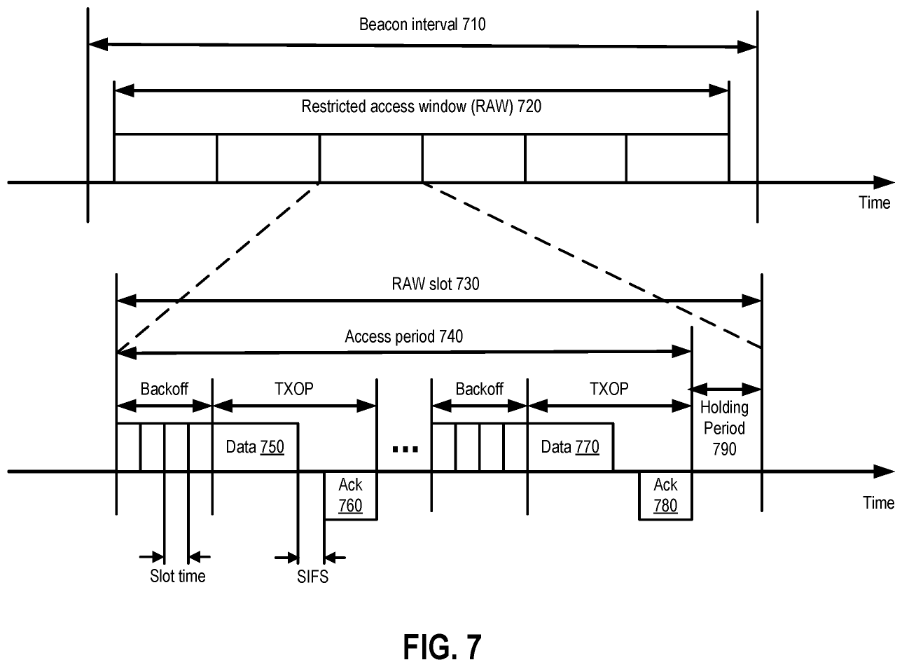

FIG. 7 is a diagram showing an example of a RAW and a RAW slot in IEEE 802.11ah. As shown in the diagram, a RAW 720 may be allocated within a beacon interval 710. The RAW 720 may be divided into multiple RAW slots, which may include RAW slot 730. An AP may group the stations of the network and assign a group of stations to RAW slot 730. In an embodiment, the AP allocates RAW 720 by transmitting a RAW parameter set (RPS) information clement (IE) that includes information/details regarding RAW 720. The information regarding RAW 720 may include, for example, the RAW start time, the RAW length/duration, and the association IDs (AIDs) of the stations assigned to the RAW. In an embodiment, the RPS IE is transmitted in a beacon frame, and each station determines which RAW slot it is assigned to based on the information included in the RPS IE.

As shown in the diagram, raw slot 730 may include an access period 740 and a holding period 790. During the access period 740, stations assigned to RAW slot 730 may contend for channel access. For example, a station assigned to RAW slot 730 may transmit data frame 750 and receive acknowledgement (ACK) frame 760 following a backoff period. The same or another station assigned to RAW slot 730 may transmit data frame 770 and receive ACK frame 780 following a backoff period. The holding period 790 provides a buffer between the RAW slot 730 and the next RAW slot.

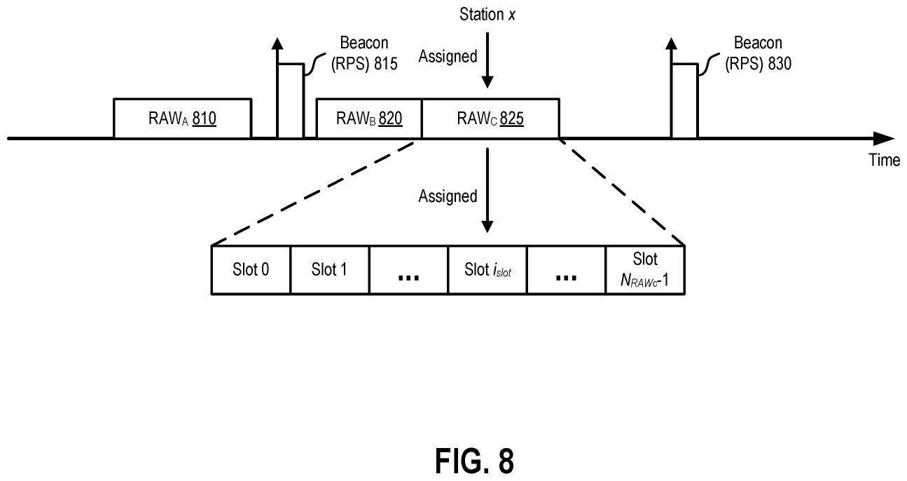

FIG. 8 is a diagram showing the use of a beacon frame that includes a RAW parameter set (RPS) element to allocate RAWs. As shown in the diagram, an AP may transmit a beacon frame 815 that includes a RAW parameter set (RPS) element (also referred to as a RPS information element). The RPS element may include information for allocating one or more RAWs during the beacon period such as information regarding RAWB 820 and RAWC 825. In an embodiment, the RPS element includes information regarding the duration of the RAWs, the number of RAWs included in the beacon interval, the number of RAW slots (e.g., equal-length RAW slots) included in each RAW, and/or the stations assigned to the RAWs.

As shown in the diagram, RAWC 825 includes multiple RAW slots (e.g., NRAWc RAW slots). One or more stations may be assigned to each RAW slot. For example, as shown in the diagram, station x may be assigned to slot islot.

Also, as shown in the diagram, one or more RAWs such as RAWA 810 may have been allocated prior to the transmission of beacon frame 815. Also, the AP may transmit a subsequent beacon frame 830 including a RPS element to allocate one or more RAWs in the next beacon interval. In an embodiment, the beacon interval may be announced in the delivery traffic indication message (DTIM) beacon or during association, and may be expressed as the number of IEEE 802.11 time units of 1024 μs between two subsequent TIM beacons.

The RAW mechanism can be seen as a combination of a deterministic and stochastic media access control mechanism that helps reduce collisions and interference between stations. The RAW mechanism may assign specific stations to slots of windows. During those windows, stations assigned to a window may use an enhanced distributed channel access/distributed coordination function (EDCA/DCF) mechanism to access the channel during their assigned slots. In this manner, the RAW mechanism may be used to restrict channel access to a specified group of stations. The RAW mechanism can be used to achieve performance improvements in dense Internet of Things (IoT) networks in which a large number of stations are expected to contend for channel access simultaneously.

Each RAW may be divided into equal-sized time slots referred to as RAW slots. Stations assigned to a RAW may be evenly assigned across the RAW slots of the RAW using a round robin assignment. If a station is assigned to a RAW, it is allowed to contend for channel access at the start of its assigned RAW slot and is not allowed to contend for channel access during any other RAW slot during that RAW.

Conventional RAW mechanisms (e.g., mechanisms based on current IEEE 802.11ah standards) group and assign stations to RAW slots in a random manner. Although the conventional RAW mechanism improves energy efficiency, a drawback of existing RAW mechanisms is that stations are only allowed to contend for channel access during limited time intervals (e.g., during their assigned RAW slots), which may increase transmission latency for certain stations. In particular, stations that require low latency transmission (e.g., for transmission of emergency data) are vulnerable to this drawback.

WLANs in the 2.4/5/6 GHz band are becoming more dense, and there is a growing need to simultaneously improve and optimize energy efficiency, throughput, and latency.

To utilize the IEEE 802.11ah based RAW mechanism in next-generation WLANs (e.g., WLANs based on enhanced/subsequent IEEE 802.11ah standards and/or 2.4/5/6 GHz next-generation WLANs), conventional RAW mechanisms that randomly group and assign stations to RAW slots without considering traffic characteristics (e.g., speed and latency) is not sufficient. An enhanced RAW mechanism is disclosed herein that allows for low latency transmission.

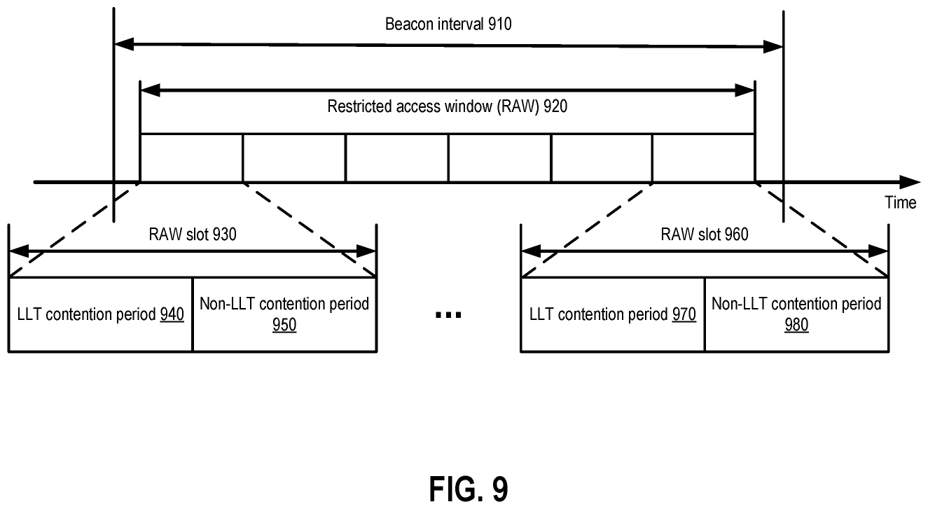

FIG. 9 is a diagram showing an enhanced RAW mechanism, where RAW slots are divided into a LLT contention period and a non-LLT contention period, according to some embodiments.

As shown in the diagram, a beacon interval 910 may include RAW 920. RAW 920 may include multiple RAW slots including RAW slot 930 and RAW slot 960. Each RAW slot may include a LLT contention period and a non-LLT contention period. For example, RAW slot 930 may include LLT contention period 940 and non-LLT contention period 950. Similarly, RAW slot 960 may include LLT contention period 970 and non-LLT contention period 980.

A LLT contention period may be a period during which only LLT stations are allowed to contend for channel access. A LLT station may be a station that needs to transmit and/or receive data (e.g., emergency data) with low latency. A non-LLT contention period may be a period during which only designated stations (the stations assigned to the RAW slot) are allowed to contend for channel access. The enhanced RAW mechanism shown in the diagram ensures that there is an opportunity for low latency transmission at the beginning of RAW slots. In an embodiment, the ratio of the duration of the LLT contention period of a RAW slot to the duration of the non-LLT contention period of the RAW slot is adjustable. In an embodiment, the ratio is determined based on the ratio of the number of LLT stations to the number of non-LLT stations in the wireless network.

In an embodiment, any LLT station in the network is allowed to contend for channel access during a LLT contention period of a RAW slot regardless of whether the LLT stations is assigned to the RAW slot or not. In another embodiment, only LLT stations that are assigned to a RAW slot are allowed to contend for channel access during a LLT contention period of the RAW slot. In an embodiment, during a non-LLT contention period of a RAW slot, only the non-LLT stations assigned to the RAW slot are allowed to contend for channel access. In an embodiment, stations are randomly grouped and assigned to RAW slots.

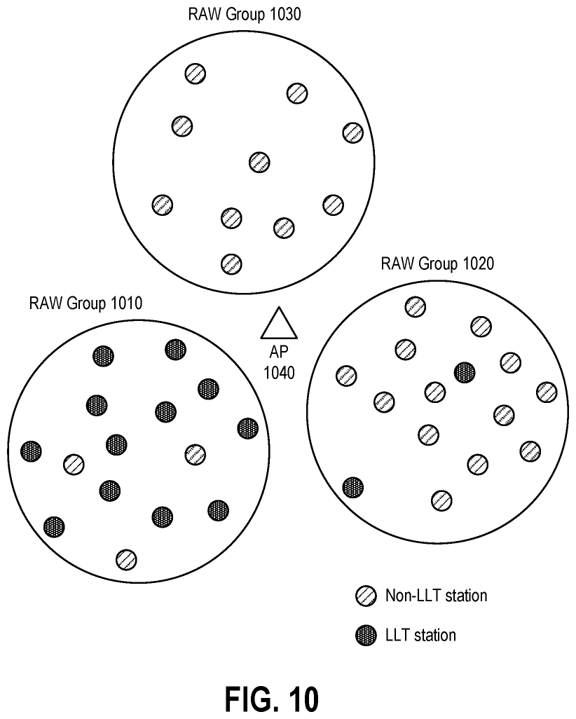

As shown in FIG. 10, the ratio of the number of LLT stations to the number of non-LLT stations in the wireless network may be different for each group assigned to a RAW slot depending on the network situation.

FIG. 10 is a diagram showing a network with RAW groups having different ratios of the number of LLT stations to the number of non-LLT stations, according to some embodiments. As shown in the diagram, the stations connected to an AP 1040 are grouped into three different RAW groups: RAW group 1010, RAW group 1020, and RAW group 1030. The different RAW groups may have different ratios of the number of LLT stations to the number of non-LLT stations. For example, RAW group 1010 has mostly LLT stations, RAW group 1020 has mostly non-LLT stations, and RAW group 1030 has only non-LLT stations.

In view of the heterogenous composition of RAW groups, in an embodiment, the duration of the LLT contention period may be different for each RAW slot depending on the number of LLT stations and/or traffic rate of the LLT stations assigned to the RAW slot. For example, the duration of the LLT contention period of a first RAW slot may be longer than the duration of the LLT contention period of a second RAW slot if the ratio of the number of LLT stations to the number of non-LLT stations of the first RAW slot is higher than the corresponding ratio of the second RAW slot.

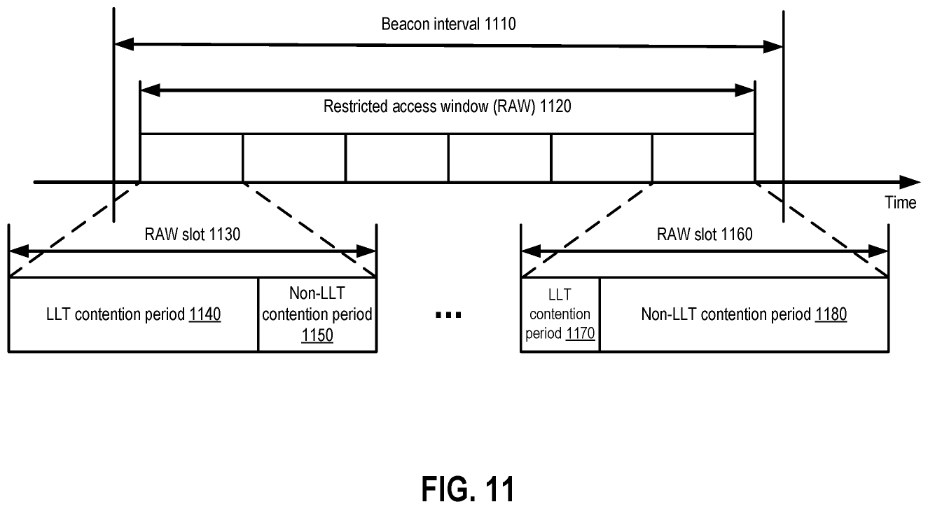

FIG. 11 is a diagram showing an enhanced RAW in which different RAW slots have different LLT contention period durations, according to some embodiments.

As shown in the diagram, a beacon interval 1110 may include RAW 1120. RAW 1120 may include multiple RAW slots including RAW slot 1130 and RAW slot 1160. Each RAW slot may include a LLT contention period and a non-LLT contention period. For example, RAW slot 1130 may include LLT contention period 1140 and non-LLT contention period 1150. Similarly, RAW slot 1160 may include LLT contention period 1170 and non-LLT contention period 1180. Notably, in this example, the duration of LLT contention period 1140 of RAW slot 1130 is different from (e.g., longer than) the duration of LLT contention period 1170 of RAW slot 1160.

In an embodiment, there are two modes of operation defined by WLANs: (1) TIM mode and (2) non-TIM mode. Stations that operate in the two modes are referred to as TIM stations and non-TIM stations, respectively. TIM stations may have periodic access to the medium. They are typically used for high bandwidth requirements and for enabling downlink access. They may wake up periodically to receive a beacon frame indicating whether there is buffered traffic at the AP. In order to prevent all of the stations from waking up for the beacon frame, a power saving mechanism called TIM segmentation may be used.

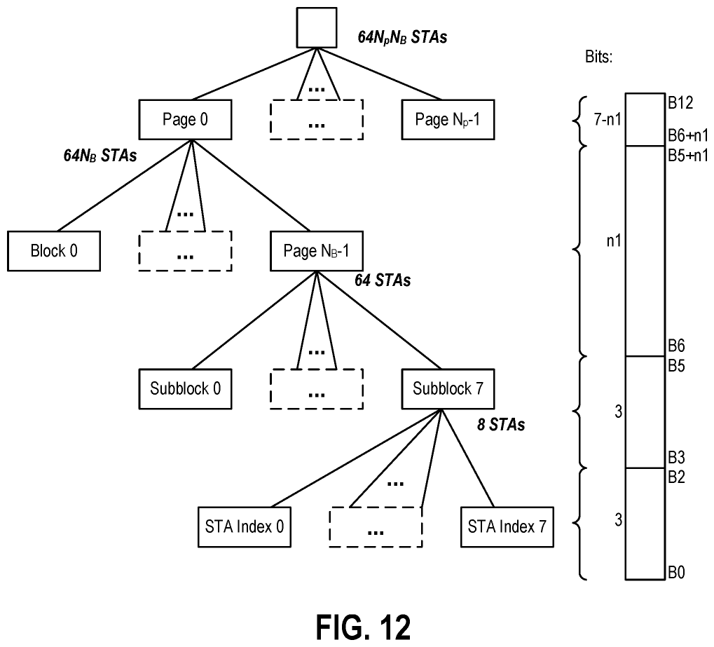

With TIM segmentation, each station is assigned a unique 13-bit AID in the range 1-8191 (AID 0 is reserved for group addressed traffic). The AID represents the station in a hierarchical structure as shown in FIG. 12. This hierarchy enables the AP to indicate in a bitmap whether a station has pending downlink data buffered at the AP on multiple levels. For example, the AP may indicate there is downlink data pending for a TIM group in the Delivery TIM (DTIM) beacon. Stations will check their own TIM group based on their assigned AID and only stations that belong to the TIM group will wake up in time for the TIM beacon of the TIM group to determine which station-index has data to expect, whereas all the remaining stations from other TIM groups may resume sleeping until the next DTIM announcement. This enables longer sleep periods for stations, which conserves energy and reduces contention.

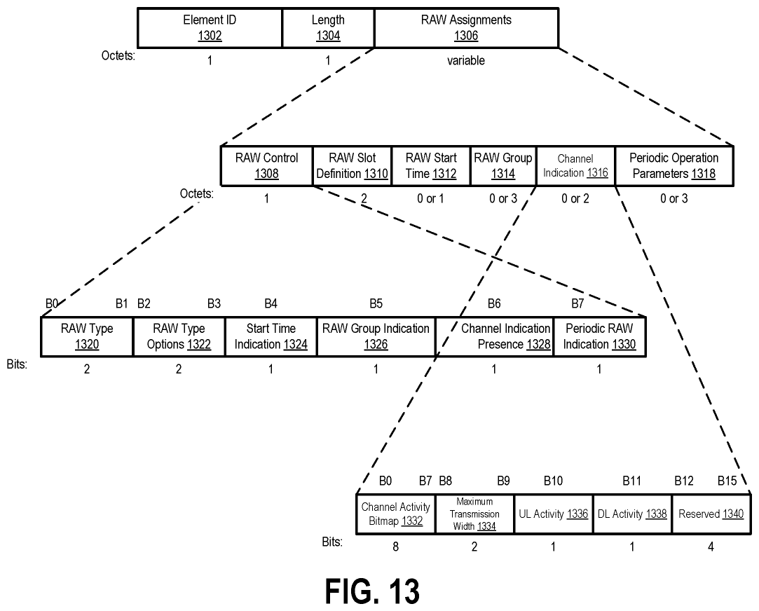

FIG. 13 is a diagram showing a RAW parameter set (RPS) element format in IEEE 802.11ah, according to some embodiments.

As shown in the diagram, the RPS element format includes an element ID field 1302 (1 octet), a length field 1304 (1 octet), and a RAW assignments field 1306 (variable length). The RAW assignments field 1306 may include a RAW control field 1308 (1 octet), a RAW slots definition field 1310 (2 octets), a RAW start time field 1312 (0 or 1 octet), a RAW group field 1314 (0 or 3 octets), a channel indication field 1316 (0 or 2 octets), and a periodic operation parameters field 1318 (0 or 3 octets). The RAW control field 1308 may include a RAW type field 1320 (2 bits), a RAW type options field 1322 (2 bits), a start time indication field 1324 (1 bit), a RAW group indication field 1326 (1 bit), a channel indication presence field 1328 (1 bit), and a periodic RAW indication field 1330 (1 bit). The channel indication field 1316 may include a channel activity bitmap field 1332 (8 bits), a maximum transmission width field 1334 (2 bits), a UL activity field 1336 (1 bit), a DL activity field 1338 (1 bit), and a reserved field 1340 (4 bits).

In this diagram bit positions are represented as Bn, where n is a number representing the position. The fields shown in the diagram may be interpreted according to IEEE 802.11 standards but the interpretation of one or more of the fields may be changed (e.g., to support an enhanced RAW mechanism), as will be described herein below.

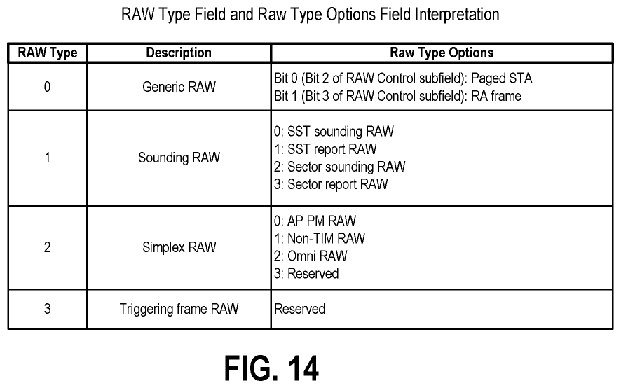

In an embodiment, the RAW type field 1320 and RAW type options field 1322 are interpreted according to the table shown in FIG. 14.

FIG. 14 is a diagram showing a table of an interpretation of the RAW type field and the RAW type options field in IEEE 802.11ah, according to some embodiments. As shown in the table, a RAW type value of “0” indicates generic RAW, a RAW type value of “1” indicates sounding RAW, a RAW type value of “2” indicates simplex RAW, and a RAW type value of “3” indicates triggering frame RAW.

When the RAW type value is “0” (generic RAW), bit 0 of the RAW type options field (which corresponds to bit B2 of the RAW control field) indicates paged STA and bit 1 of the RAW type options field ((which corresponds to bit B3 of the RAW control field)) indicates RA (resource allocation) frame. When the RAW type value is “1” (sounding RAW), a RAW type options value of “0” indicates a SST (subchannel selective transmission) sounding RAW, a RAW type options value of “1” indicates a SST report RAW, a RAW type options value of “2” indicates a sector sounding RAW, and a RAW type options value of “3” indicates a sector report RAW. When the RAW type value is “2” (simplex RAW), a RAW type options value of “0” indicates an AP PM (access point power management) RAW, a RAW type options value of “1” indicates a non-TIM (traffic indication map) RAW, a RAW type options value of “2” indicates an omni RAW, and a RAW type options value of “3” is reserved. When the RAW type value is “3” (triggering frame RAW), the RAW type options field is reserved.

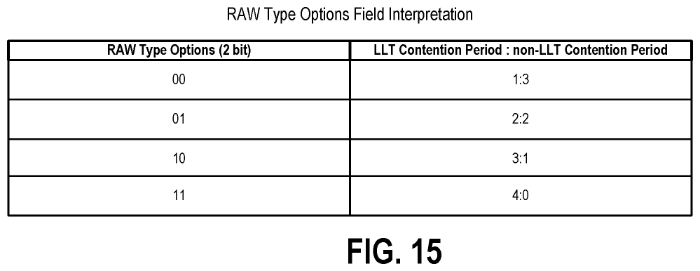

In an embodiment, the value of the RAW type field is set to “3” to indicate that the RAW is an enhanced RAW for low latency transmission (instead of indicating triggering frame RAW). In an embodiment, the RAW type options field (2 bits) is used to indicate the ratio of the duration of the LLT contention period to the duration of the non-LLT contention period. A table of an example interpretation of the RAW type options field is shown in FIG. 15.

FIG. 15 is a diagram showing a table of an interpretation of the RAW type options field, according to some embodiments.

As shown in the first row of the table, the value of the RAW type options field being set to binary “00” indicates that the ratio of the duration of the LLT contention period to the duration of the non-LLT contention period is “1:3” (the duration of the non-LLT contention period is three times longer than the duration of the LLT contention period). As shown in the second row of the table, the value of the RAW type options field being set to binary “01” indicates that the ratio of the duration of the LLT contention period to the duration of the non-LLT contention period is “2:2” (the duration of the LLT contention period and the duration of the non-LLT contention period are the same). As shown in the third row of the table, the value of the RAW type options field being set to binary “10” indicates that the ratio of the duration of the LLT contention period to the duration of the non-LLT contention period is “3:1” (the duration of the LLT contention period is three times longer than the duration of the non-LLT contention period). As shown in the fourth row of the table, the value of the RAW type options field being set to binary “11” indicates that the ratio of the duration of the LLT contention period to the duration of the non-LLT contention period is “4:0” (the RAW slot only includes the LLT contention period and does not include the non-LLT contention period).

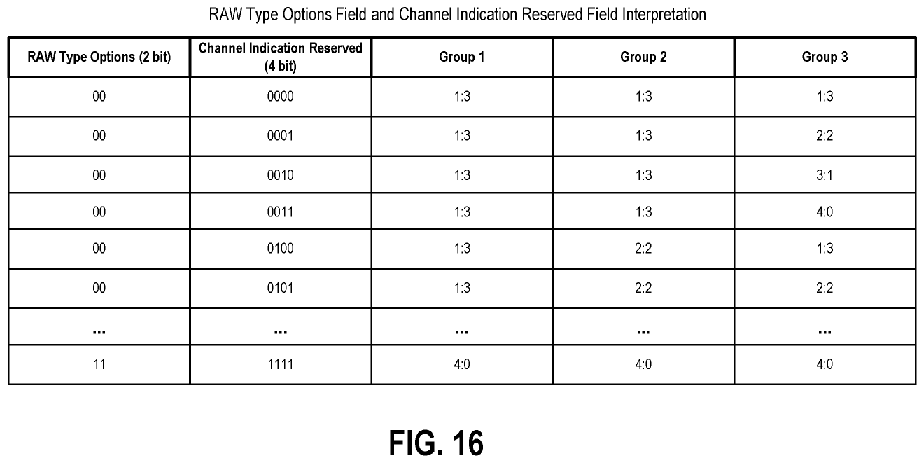

In an embodiment, the RAW type options field (2 bits) and the reserved bits (4 bits) of the channel indication field are used to indicate the ratio of the duration of the LLT contention period to the duration of the non-LLT contention period for different RAW slots (e.g., three different RAW slots). A table of an example interpretation of the RAW type options field and the reserved bits of the channel indication field is shown in FIG. 16.

FIG. 16 is a diagram showing a table of an interpretation of the RAW type options field and the channel indication reserved field, according to some embodiments.

As shown in the first row of the table, the value of the RAW type options field being set to binary “00” and the value of the reserved bits of the channel indication field being set to binary “0000” indicates that the first group (first RAW slot) has a ratio of “1:3” (the duration of the non-LLT contention period is three times longer than the duration of the LLT contention period), the second group has a ratio of “1:3”, and the third group has a ratio of “1:3”. As shown in the second row of the table, the value of the RAW type options field being set to binary “00” and the value of the reserved bits of the channel indication field being set to binary “0001” indicates that the first group (first RAW slot) has a ratio of “1:3”, the second group has a ratio of “1:3”, and the third group has a ratio of “2:2” (the duration of the LLT contention period and the duration of the non-LLT contention period are the same). The remaining rows of the table can be interpreted in a similar manner as described above, and thus are not described further herein for the sake of conciseness.

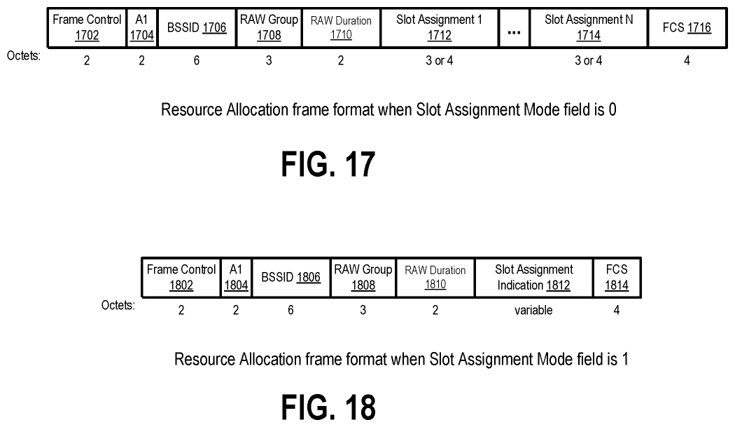

A resource allocation (RA) frame is broadcasted to all non-AP stations that belong to a RAW group identified by the RAW group field of a previously transmitted RPS element, where the RAW type field indicates a generic RAW and the RAW type options field indicates a RA frame. The RA frame may signal the presence of downlink buffered data for paged stations and their assigned RAW slots for both uplink and downlink service periods. The RA frame may have two types of formats depending on the slot assignment mode indicated in the frame control field. The two different RA frame formats are show in FIGS. 17 and 18, respectively.

FIG. 17 is a diagram showing a RA frame format when the slot assignment mode is “0”, according to some embodiments.

As shown in the diagram, the RA frame format includes a frame control field 1702 (2 octets), an Al field 1704 (2 octets), a BSSID field 1706 (6 octets), a RAW group field 1708 (3 octets), a RAW duration field 1710 (2 octets), multiple slot assignment fields (e.g., including slot assignment/field 1712 and slot assignment N field 1714) (each field being 3 or 4 octets), and FCS field 1716 (4 octets).

FIG. 18 is a diagram showing a RA frame format when slot assignment mode is “1”, according to some embodiments.

As shown in the diagram, the resource allocation frame format includes a frame control field 1802 (2 octets), an A1 field 1804 (2 octets), a BSSID field 1806 (6 octets), a RAW group field 1808 (3 octets), a RAW duration field 1810 (2 octets), a slot assignment indication field 1812 (variable length), and FCS field 1814 (4 octets).

The RAW group field may indicate the STA AIDs that are assigned to the RAW. The AIDs indicated in the RAW group field may be identical to the AIDs indicated in the RAW group field of the RPS element with the value in the RAW type field set to “0” and the value of the second bit in the RAW type options field set to “1” in the RAW control field. STAs that wake up and receive the RA frame may use this field to determine whether they are assigned to the RAW based on whether their AIDs are included in the RAW group field.

The RAW duration field may include an unsigned integer expressed in us that indicates the duration of the RAW in which the RA frame is broadcasted.

The slot assignment field may be used to indicate a partial AID of a STA or GID (group ID) of STAs in the corresponding MU (multi-user) group and their corresponding slots of medium access within the current RAW. The slot assignment fields may indicate the number of RAW slots allocated for all STAs in the RAW group (information in the slot assignment fields may expressed as bitmaps).

In an embodiment, a periodic RAW (PRAW) scheme is used. With the PRAW scheme, an AP may schedule a periodically occurring RAWs. Once a PRAW is allocated, the allocation indication is broadcasted by the AP such that every TIM STA may identify the allocation of the PRAW. However, it is not necessary for the AP to indicate the PRAW allocation in every beacon frame transmitted in the beacon interval or short beacon interval, for which the PRAW is allocated. The parameters in the RAW assignments field for the PRAW shall not be changed until updated PRAW information is broadcasted. In order to perform such an operation, the PRAW may be defined and used in the manner of the tables shown in FIGS. 15 and 16. For example, the RAW types options field (2 bits) may be used to indicate the cycle ratio of LLT contention period to non-LLT contention period in the PRAW (e.g., similar to the encoding shown in FIG. 15) or the ratio of LLT contention period to non-LLT contention period can be specified differently for multiple groups (e.g., similar to the encoding shown in FIG. 16).

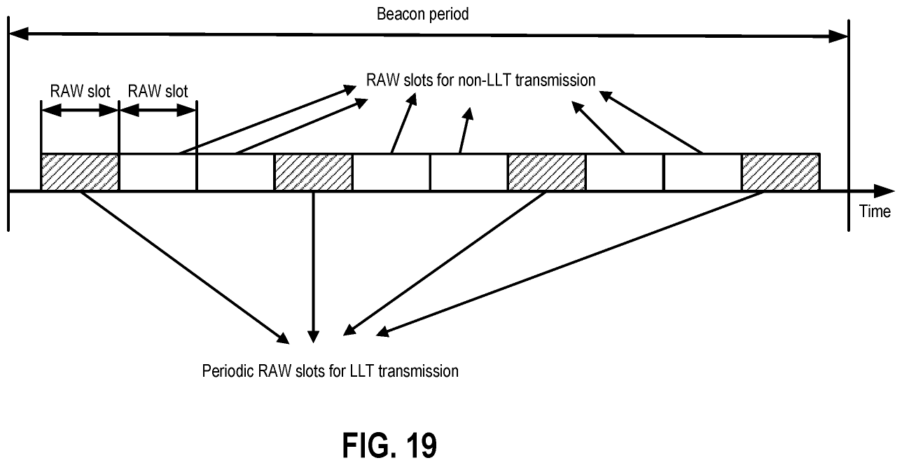

FIG. 19 is a diagram showing low latency transmission using periodic RAW slots, according to some embodiments.

As shown in the diagram, a beacon period may include RAW slots for low latency transmission and RAW slots for non-low latency transmission. RAW slots for low latency transmission may be allocated in a periodic manner (e.g., at fixed intervals). In this example, RAW slots for low latency transmission and RAW slots for non-low latency transmission are allocated at a ratio of 1:2. That is, one RAW slot for low latency transmission is allocated after every two RAW slots for non-low latency transmission.

The enhanced RAW mechanism disclosed herein may provide one or more technical advantages over conventional RAW mechanisms. With conventional RAW mechanisms, stations are randomly grouped and assigned to RAW slots. If a LLT station is assigned to a later RAW slot, the transmission of the LLT station may be delayed, thereby increasing the transmission latency. An advantage of the enhanced RAW mechanism disclosed herein is that it allows LLT stations to attempt transmission at the beginning of RAW slots. In this way, LLT stations are given priority for transmission during a RAW, which helps reduces the transmission latency of LLT stations. While certain advantages are mentioned herein, those skilled in the art will appreciate that embodiments disclosed herein can confer other advantages.

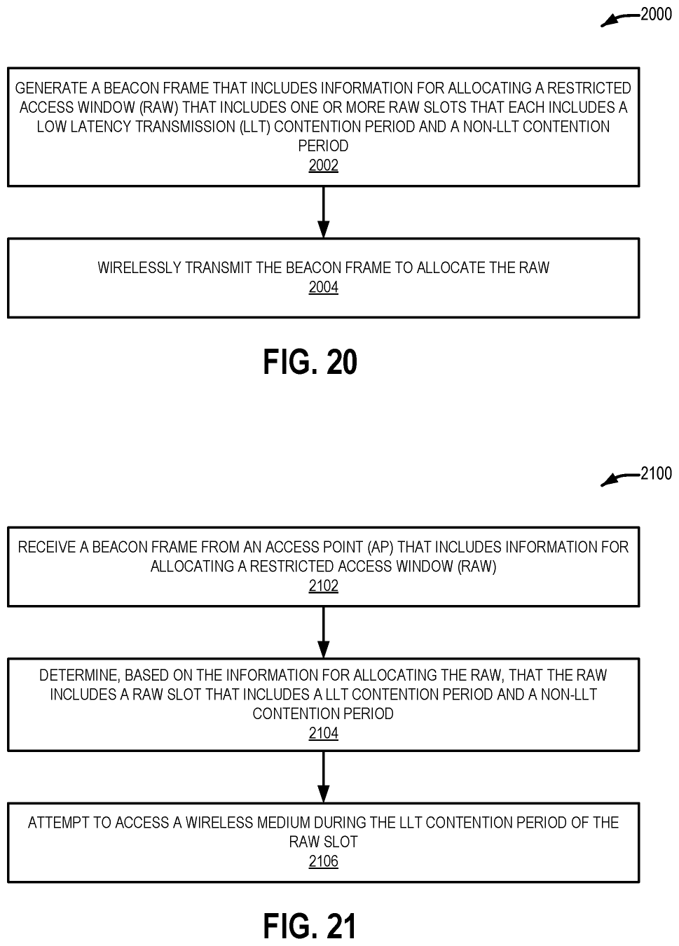

Turning now to FIG. 20, a method 2000 will be described for implementing an enhanced RAW mechanism for low latency transmission, in accordance with an example embodiment. The method 2000 may be performed by one or more devices described herein. For example, the method 2000 may be performed by a wireless device 104 functioning as an AP in a wireless network.

Additionally, although shown in a particular order, in some embodiments the operations of the method 2000 (and the other methods shown in the other figures) may be performed in a different order. For example, although the operations of the method 2000 are shown in a sequential order, some of the operations may be performed in partially or entirely overlapping time periods.

As shown in FIG. 20, the method 2000 may commence at operation 2002 with an AP generating a beacon frame that includes information for allocating a RAW that includes one or more RAW slots that each includes a LLT contention period and a non-LLT contention period.

At operation 2004, the AP wirelessly transmits the beacon frame to allocate the RAW.

In an embodiment, any LLT station is allowed to access a wireless medium during the LLT contention period of a RAW slot regardless of whether that LLT station is assigned to the RAW slot, wherein only non-LLT stations assigned to the RAW slot are allowed to access the wireless medium during the non-LLT contention period of the RAW slot.

In an embodiment, the LLT contention period of a RAW slot comes before the non-LLT contention period of the RAW slot. In an embodiment, a duration of the LLT contention period of the RAW slot is different from a duration of the non-LLT contention period of the RAW slot. In an embodiment, the information for allocating the RAW indicates a ratio of the duration of the LLT contention period of the RAW slot to the duration of the non-LLT contention period of the RAW slot. In an embodiment, the beacon frame includes a RPS element, wherein the RPS element includes a RAW control field, wherein the RAW control field includes a RAW type options field, wherein the RAW type options field is used to indicate the ratio.

In an embodiment, the one or more RAW slots includes at least a first RAW slot and a second RAW slot, wherein a duration of the LLT contention period of the first RAW slot is different from a duration of the LLT contention period of the second RAW slot. In an embodiment, the duration of the LLT contention period of the first RAW slot is determined based on a number of LLT stations assigned to the first RAW slot and the duration of the LLT contention period of the second RAW slot is determined based on a number of LLT stations assigned to the second RAW slot.

In an embodiment, the one or more RAW slots includes at least a first RAW slot, a second RAW slot, and a third RAW slot. In an embodiment, the information for allocating the RAW indicates a first ratio of a duration of the LLT contention period of the first RAW slot to a duration of the non-LLT contention period of the first RAW slot, a second ratio of a duration of the LLT contention period of the second RAW slot to a duration of the non-LLT contention period of the second RAW slot, and a third ratio of a duration of the LLT contention period of the third RAW slot to a duration of the non-LLT contention period of the third RAW slot. In an embodiment, the beacon frame includes a RPS element, wherein the RPS element includes a RAW control field, wherein the RAW control field includes a RAW type options field and a channel indication field, wherein the RAW type options field and a portion of the channel indication field are used to indicate the first ratio, the second ratio, and the third ratio.

In an embodiment, the beacon frame includes a RPS element, wherein the RPS element includes a RAW control field, wherein the RAW control field includes a RAW type field, wherein a value of the RAW type field is set to “3” to indicate that the RAW is an enhanced RAW that includes the one or more RAW slots that each includes the LLT contention period and the non-LLT contention period.

In an embodiment, the AP generates a second beacon frame that includes information for allocating periodic RAWs, wherein each RAW of the periodic RAWs includes one or more RAW slots for LLT transmission that are allocated at fixed intervals.

Turning now to FIG. 21, a method 2100 will be described for implementing an enhanced RAW mechanism for low latency transmission, in accordance with an example embodiment. The method 2100 may be performed by one or more devices described herein. For example, the method 2100 may be performed by a wireless device 104 functioning as a LLT station in a wireless network.

As shown in FIG. 21, the method 2100 may commence at operation 2102 with a LLT station wirelessly receiving a beacon frame from an AP that includes information for allocating a RAW.

At operation 2104, the LLT station determines, based on the information for allocating the RAW, that the RAW includes a RAW slot that includes a LLT contention period and a non-LLT contention period. In an embodiment, the beacon frame includes a RPS element, wherein the RPS element includes a RAW control field, wherein the RAW control field includes a RAW type field, wherein the determination that the RAW includes the RAW slot that includes the LLT contention period and the non-LLT contention period is based on a determination that a value of the RAW type field is set to “3”.

At operation 2106, the LLT station attempts to access a wireless medium during the LLT contention period of the RAW.slot.

In an embodiment, the LLT station is not assigned to the RAW slot (and can attempt to access the wireless medium during the LLT contention period of any RAW slot).

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a wireless device functioning as an access point (AP) in a wireless network, the method comprising:
generating a beacon frame that includes information for allocating a restricted access window (RAW) that includes one or more RAW slots that each includes a low latency transmission (LLT) contention period and a non-LLT contention period; and
wirelessly transmitting the beacon frame to allocate the RAW.

2. The method of claim 1, wherein any LLT station is allowed to access a wireless medium during the LLT contention period of a RAW slot regardless of whether that LLT station is assigned to the RAW slot, wherein only non-LLT stations assigned to the RAW slot are allowed to access the wireless medium during the non-LLT contention period of the RAW slot.

3. The method of claim 1, wherein the LLT contention period of a RAW slot comes before the non-LLT contention period of the RAW slot.

4. The method of claim 3, wherein a duration of the LLT contention period of the RAW slot is different from a duration of the non-LLT contention period of the RAW slot.

5. The method of claim 4, wherein the information for allocating the RAW indicates a ratio of the duration of the LLT contention period of the RAW slot to the duration of the non-LLT contention period of the RAW slot.

6. The method of claim 5, wherein the beacon frame includes a RAW parameter set (RPS) element, wherein the RPS element includes a RAW control field, wherein the RAW control field includes a RAW type options field, wherein the RAW type options field is used to indicate the ratio.

7. The method of claim 1, wherein the one or more RAW slots includes at least a first RAW slot and a second RAW slot, wherein a duration of the LLT contention period of the first RAW slot is different from a duration of the LLT contention period of the second RAW slot.

8. The method of claim 7, wherein the duration of the LLT contention period of the first RAW slot is determined based on a number of LLT stations assigned to the first RAW slot and the duration of the LLT contention period of the second RAW slot is determined based on a number of LLT stations assigned to the second RAW slot.

9. The method of claim 1, wherein the one or more RAW slots includes at least a first RAW slot, a second RAW slot, and a third RAW slot.

10. The method of claim 9, wherein the information for allocating the RAW indicates a first ratio of a duration of the LLT contention period of the first RAW slot to a duration of the non-LLT contention period of the first RAW slot, a second ratio of a duration of the LLT contention period of the second RAW slot to a duration of the non-LLT contention period of the second RAW slot, and a third ratio of a duration of the LLT contention period of the third RAW slot to a duration of the non-LLT contention period of the third RAW slot.

11. The method of claim 10, wherein the beacon frame includes a RAW parameter set (RPS) element, wherein the RPS element includes a RAW control field, wherein the RAW control field includes a RAW type options field and a channel indication field, wherein the RAW type options field and a portion of the channel indication field are used to indicate the first ratio, the second ratio, and the third ratio.

12. The method of claim 1, wherein the beacon frame includes a RAW parameter set (RPS) element, wherein the RPS element includes a RAW control field, wherein the RAW control field includes a RAW type field, wherein a value of the RAW type field is set to “3” to indicate that the RAW is an enhanced RAW that includes the one or more RAW slots that each includes the LLT contention period and the non-LLT contention period.

13. The method of claim 1, further comprising:
generating a second beacon frame that includes information for allocating periodic RAWs, wherein each RAW of the periodic RAWs includes one or more RAW slots for LLT transmission that are allocated at fixed intervals.

14. A method performed by a wireless device functioning as a low latency transmission (LLT) station in a wireless network, the method comprising:
receiving a beacon frame from an access point (AP) that includes information for allocating a restricted access window (RAW);
determining, based on the information for allocating the RAW, that the RAW includes a RAW slot that includes a LLT contention period and a non-LLT contention period; and
attempting to access a wireless medium during the LLT contention period of the RAW.

15. The method of claim 14, wherein the LLT station is not assigned to the RAW slot.

16. The method of claim 14, wherein the beacon frame includes a RAW parameter set (RPS) element, wherein the RPS element includes a RAW control field, wherein the RAW control field includes a RAW type field, wherein the determination that the RAW includes the RAW slot that includes the LLT contention period and the non-LLT contention period is based on a determination that a value of the RAW type field is set to “3”.

17. A wireless device to function as an access point (AP) in a wireless network, the wireless device comprising:
a radio frequency transceiver;
a memory device storing a set of instructions; and
a processor coupled to the memory device, wherein the set of instructions when executed by the processor causes the AP to perform:
generating a beacon frame that includes information for allocating a restricted access window (RAW) that includes one or more RAW slots that each includes a low latency transmission (LLT) contention period and a non-LLT contention period; and
wirelessly transmitting the beacon frame to allocate the RAW.

18. A wireless device to function as a low latency transmission (LLT) station in a wireless network, the wireless device comprising:
a radio frequency transceiver;
a memory device storing a set of instructions; and
a processor coupled to the memory device, wherein the set of instructions when executed by the processor causes the LLT station to perform:
receiving a beacon frame from an access point (AP) that includes information for allocating a restricted access window (RAW);
determining, based on the information for allocating the RAW, that the RAW includes a RAW slot that includes a LLT contention period and a non-LLT contention period; and
attempting to access a wireless medium during the LLT contention period of the RAW.
